(19) United States
(12) Patent Application Publication
(10) Pub. No.: US 2020/0398823 A1
(43) Pub. Date: Dec. 24, 2020

(54) TRAILER

(71) Applicant: HONDA MOTOR CO., LTD., Tokyo (JP)

(72) Inventor: Takeshi Oba, Wako-shi (JP)

(73) Assignee: HONDA MOTOR CO., LTD., Tokyo (JP)

(21) Appl. No.: 16/901,048

(22) Filed: Jun. 15, 2020

(30) Foreign Application Priority Data
Jun. 18, 2019 (JP) 2019-113025

(51) Int. Cl. B60W 30/06; B62D 59/04; G05D 1/00; B62D 15/02; G05D 1/02

(52) U.S. Cl. CPC B60W 30/06; B62D 59/04; B60R 11/04; B62D 15/029; G05D 1/0212; G05D 1/0011

(57) ABSTRACT

An electric self-traveling trailer capable of performing automatic following traveling to a towing vehicle without mechanical connection, includes a detection unit configured to detect a peripheral situation, a recognition unit configured to recognize a parking space based on a detection result of the detection unit, a moving control unit configured to move the trailer to the parking space, and an instruction unit configured to transmit, to the towing vehicle, a following instruction for making the towing vehicle follow the trailer moving to the parking space.

### CROSS-REFERENCE TO RELATED APPLICATION(S)

This application claims priority to and the benefit of Japanese Patent Application No. 2019-113025 filed on Jun. 18, 2019, the entire disclosure of which is incorporated herein by reference.

### BACKGROUND OF THE INVENTION

### Field of the Invention

The present invention relates to a trailer.

### Description of the Related Art

A camper trailer can ensure a wide comfortable living space and enhance installed equipment generally as compared to a recreational vehicle. In addition, both the initial cost and the running cost can be suppressed low. Furthermore, when the camper trailer is disconnected, the towing vehicle can be used for ordinary movement, and the trailer can be used as an outdoor living space. Such a trailer is highly convenient but needs experiences in maneuvering at the time of towing. There have been proposed techniques for improving the maneuverability at the time of towing (for example, Japanese Patent Laid-Open Nos. 2011-152831, 10-157652, and 6-219348). Additionally, along with the development of automation techniques for vehicles, following travel to a preceding vehicle and automatic parking have also been proposed (for example, Japanese Patent Laid-Open Nos. 2000-113399 and 2018-34659).

Since the total length of a towing vehicle and a trailer in a mechanical connection state is long, there is a limitation on parking lots where these can park on the way. In addition, when parking the trailer, an operation or external confirmation is difficult because of the long total length or cooperation with the towing vehicle, and there are concerns from the viewpoint of security/safety/convenience.

If an automatic following technique or automatic parking technique is applied to the trailer, the trailer can automatically follow the towing vehicle without mechanical connection. This can improve the convenience in terms of maneuverability for the occupant of the towing vehicle and also allows the towing vehicle and the trailer to park in different parking spaces at a parking lot, thereby improving the convenience for the occupant of the towing vehicle from the viewpoint of parking. However, if the trailer and the towing vehicle are completely separated, it may be difficult for the driver to confirm the trailer.

### SUMMARY OF THE INVENTION

It is an object of the present invention to provide a technique of maintaining a towing state even in automatic parking of a trailer and enabling safe and convenient parking that a driver can easily confirm.

According to an aspect of the present invention, there is provided an electric self-traveling trailer capable of performing automatic following traveling to a towing vehicle without mechanical connection, comprising:

a detection unit configured to detect a peripheral situation;

a recognition unit configured to recognize a parking space based on a detection result of the detection unit;

a moving control unit configured to move the trailer to the parking space; and

an instruction unit configured to transmit, to the towing vehicle, a following instruction for making the towing vehicle follow the trailer moving to the parking space.

Further features of the present invention will become apparent from the following description of exemplary embodiments (with reference to the attached drawings).

### BRIEF DESCRIPTION OF THE DRAWINGS

FIG. 1 is a block diagram of a trailer and a towing vehicle according to an embodiment of the present invention;

FIG. 2 is an explanatory view of automatic parking control of the trailer;

FIG. 3 is an explanatory view of automatic parking control of the trailer;

FIG. 4 is an explanatory view of automatic parking control of the trailer;

FIG. 5 is an explanatory view of automatic parking control of the trailer;

FIG. 6 is an explanatory view of automatic parking control of the trailer;

FIG. 7 is an explanatory view of automatic parking control of the trailer;

FIG. 8 is an explanatory view of automatic parking control of the trailer;

FIG. 9 is an explanatory view of automatic parking control of the trailer;

FIGS. 10A and 10B are explanatory views of start control of the trailer from a parking space;

FIG. 11 is a flowchart showing an example of processing of the control units of the trailer and the towing vehicle;

FIG. 12 is a flowchart showing an example of processing of the control units of the trailer and the towing vehicle;

FIGS. 13A and 13B are explanatory views of examples of separation conditions; and

FIG. 14 is a flowchart showing another example of processing of the control unit of the towing vehicle.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

### Outline of Trailer and Towing Vehicle

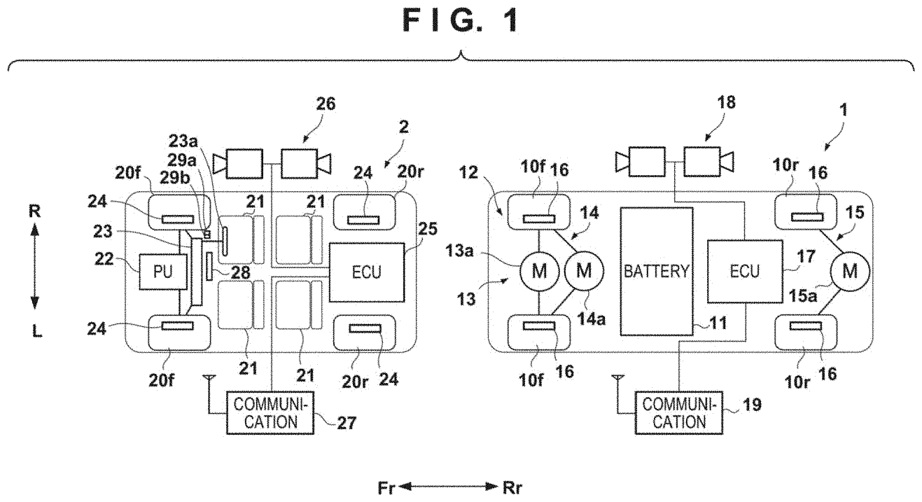

FIG. 1 is a block diagram of a trailer 1 and a towing vehicle 2 according to an embodiment of the present invention. In FIG. 1, Fr, Rr, L, and R indicate front, rear, left, and right at the time of advance traveling of the trailer 1 and the towing vehicle 2. The trailer 1 is, for example, a camper trailer, and includes living spaces (not shown) such as a sofa, a bed, a shower, a bathroom, and a kitchen. On the other hand, the trailer is a vehicle including no driver's seat or a driving mechanism by an occupant, and is unmanned during traveling. The trailer 1 according to this embodiment is a four-wheeled vehicle including two front wheels 10f and two rear wheels 10r, but may be a three-wheeled vehicle.

The trailer 1 is an electric self-traveling vehicle including a battery 11 as a main power supply. The battery 11 is a secondary battery such as a lithium ion battery, and the trailer 1 self-travels by power supplied from the battery 11. The trailer 1 includes an electric traveling mechanism 12. The electric traveling mechanism 12 includes a traveling mechanism 13, steering mechanisms 14 and 15, and braking mechanisms 16.

The traveling mechanism 13 is a mechanism configured to make the trailer 1 advance or retreat using a traveling motor 13a as a driving source, and in this embodiment, uses the front wheels 10f as driving wheels. The front wheels 10f and the rear wheels 10r are each provided with the braking mechanism 16 such as a disc brake.

The steering mechanism 14 is a mechanism configured to give a steering angle to the front wheels 10f using a steering motor 14a as a driving source. The steering mechanism 15 is a mechanism configured to give a steering angle to the rear wheels 10r using a steering motor 15a as a driving source. That is, the electric traveling mechanism 12 according to this embodiment includes a four-wheel steering mechanism that sheers the front wheels 10f and the rear wheels 10r, but it may be a two-wheel steering mechanism that steers only the front wheels 10f or rear wheels 10r.

The trailer 1 includes a detection unit 18 configured to detect the peripheral situation. The detection unit 18 is an external sensor group configured to monitor the periphery of the trailer 1. The external sensors are, for example, cameras, radars, and LiDARs (Light Detection and Ranging). The external sensors can be provided on the front portion, the rear portion, and the left and right side portions of the trailer 1 whereby it is possible to monitor all the directions of the trailer 1. The trailer 1 also includes a communication device 19. The communication device 19 includes a communication unit configured to perform vehicle-to-vehicle communication with the towing vehicle 2.

The trailer 1 includes a control unit (ECU) 17. The control unit 17 includes a processor represented by a CPU, a storage device such as a semiconductor memory or a hard disk, and an interface to an external device. The storage device stores programs to be executed by the processor, and data (map information) to be used by the processor to perform processing. A plurality of sets of a processor, a storage device, and an interface may be provided for each function of the trailer 1 and configured to be communicable with each other. The control unit 17 performs automatic following traveling control to the towing vehicle 2 or parking control of the trailer 1 to be described later based on the detection result of the detection unit 18 or information acquired by communication of the communication device 19 with the towing vehicle 2.

The towing vehicle 2 is a four-wheeled vehicle including two front wheels 20f and two rear wheels 20r, and is, for example, a passenger vehicle having an automated driving function. The towing vehicle 2 includes four seats 21 on front and rear lines. The number of seats is not limited to this, and, for example, three seats may be provided on the rear line. The right seat 21 on the front line is a driver's seat at which a steering wheel 23a is arranged. An accelerator pedal 29a and a brake pedal 29b are provided on the foot side of the seat 21, which accept an acceleration/deceleration operation and a braking operation of the occupant, respectively. In addition, a shift lever (not shown) that allows the occupant to select advance or retreat of the towing vehicle 2 is provided near the seat 21. An input/output device 28 configured to display information to the occupant is arranged near the driver's seat. The input/output device 28 according to this embodiment is a touch panel type display device, which not only displays information to the occupant but also serves as an input device used by the occupant to input an instruction to the towing vehicle 2. The input/output device 28 may be a voice input/output device, or may be a device serving as both a touch panel type display device and a voice input/output device.

The towing vehicle 2 includes a power unit (PU) 22 configured to make the towing vehicle 2 advance or retreat. The power unit 22 includes, for example, an engine and an automatic transmission, and drives the front wheels 20f The power unit 22 can accelerate/decelerate the towing vehicle 2 by an operation of the driver on an accelerator pedal 29a, and can also automatically accelerate/decelerate the towing vehicle 2 under the control of a control unit (ECU) 25. The front wheels 20f and the rear wheels 20r are each provided with a braking mechanism 24 such as a disc brake. The braking mechanism 24 can brake the towing vehicle 2 by an operation of the driver on a brake pedal 29b, and can also automatically brake the towing vehicle 2 under the control of the control unit (ECU) 25.

The towing vehicle 2 includes an electric power steering mechanism 23. The electric power steering mechanism 23 gives a steering angle to the front wheels 20f by an operation of the driver on the steering wheel 23a. In addition, the electric power steering mechanism 23 has an automatic steering function using a motor as a driving source, and can give a steering angle to the front wheels 20f without depending on the operation of the driver.

The towing vehicle 2 includes a detection unit 26 configured to detect the peripheral situation. The detection unit 26 is an external sensor group configured to monitor the periphery of the towing vehicle 2. The external sensors are, for example, cameras, radars, and LiDARs (Light Detection and Ranging). The external sensors can be provided on the front portion, the rear portion, and the left and right side portions of the towing vehicle 2 whereby it is possible to monitor the all directions of the towing vehicle 2. The towing vehicle 2 also includes a communication device 27. The communication device 27 includes a communication unit configured to perform vehicle-to-vehicle communication with the trailer 1, and a communication unit configured to communicate with a server that provides various kinds of information via a communication network such as the Internet.

The towing vehicle 2 includes the control unit 25. The control unit 25 includes a processor represented by a CPU, a storage device such as a semiconductor memory or a hard disk, and an interface to an external device. The storage device stores programs to be executed by the processor, and data to be used by the processor to perform processing. A plurality of sets of a processor, a storage device, and an interface may be provided for each function of the towing vehicle 2 and configured to be communicable with each other.

The control unit 25 can perform automated driving or traveling support of the towing vehicle 2 based on the detection result of the detection unit 26 or information or map information acquired by the communication device 27. In addition, the control unit 25 can issue various kinds of instructions to the trailer 1 via the communication device 27.

### Automatic Following Control

The trailer 1 can perform automatic following traveling to the towing vehicle 2 without connection. For example, the control unit 17 of the trailer 1 identifies the leading towing vehicle 2 based on the detection result of the detection unit 18, and follows the towing vehicle 2 while maintaining a predetermined distance from the towing vehicle 2. To facilitate identification of the towing vehicle 2, an identification mark may be provided on the rear portion of the towing vehicle 2, and the detection unit 18 may include a camera configured to capture and recognize the identification mark. In addition, the control unit 17 and the control unit 25 may collate each other's ID information by vehicle-to-vehicle communication and mutually recognize whether the vehicles should be set in a towing relationship.

The control unit 25 of the towing vehicle 2 transmits the information of the guidance route of the towing vehicle 2 and acceleration/deceleration, braking, and right/left turn of the towing vehicle 2 to the trailer 1 by vehicle-to-vehicle communication. The control unit 17 of the trailer 1 recognizes a traveling lane based on the received information or by detecting a lane division line, a curbstone, and the like by the detection unit 18, and follows the towing vehicle 2 while maintaining the traveling lane by referring to map information. The control unit 25 may instruct a recommended inter-vehicle distance to the control unit 17, and the control unit 17 may control the traveling of the trailer 1 so as to maintain the recommended inter-vehicle distance.

### Automatic Parking Control

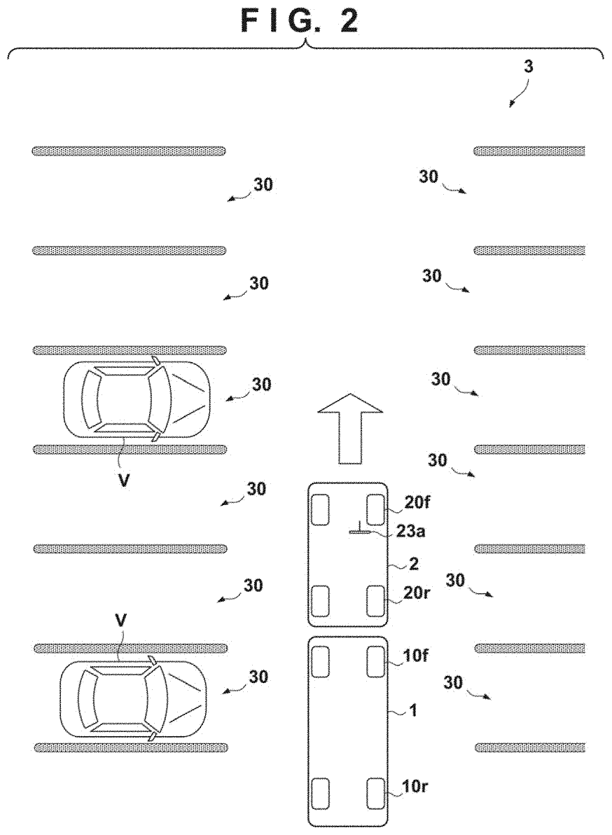

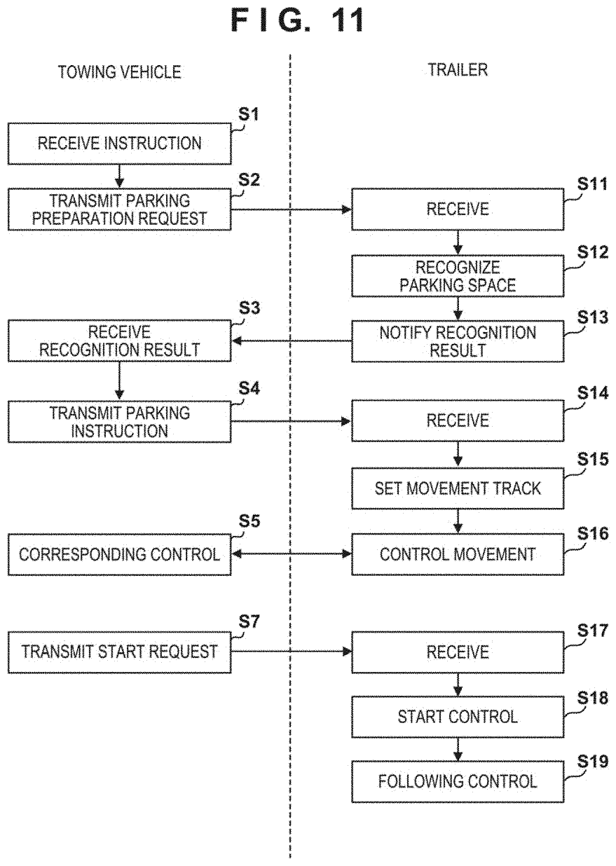

The trailer 1 according to this embodiment is not mechanically connected to the towing vehicle 2, and can therefore park in a parking space different from that of the towing vehicle 2. This can increase choices of parking lots on the way and improve the convenience for the occupant of the towing vehicle 2 from the viewpoint of parking. An example of automatic parking control of the trailer 1 will be described with reference to FIGS. 2 to 9. FIGS. 2 to 9 are views schematically showing the behaviors of the trailer 1 and the towing vehicle 2 in the automatic parking control. FIG. 11 is a flowchart showing an example of processing of the control unit 17 of the trailer 1 and the control unit 25 of the towing vehicle 2. The drawings will appropriately be referred to.

FIG. 2 shows a stage in which the towing vehicle 2 is entering a parking lot 3. The trailer 1 is executing automatic following control to the towing vehicle 2. A plurality of parking spaces 30 exist in the parking lot 3. When the occupant of the towing vehicle 2 instructs to make preparation for parking of the trailer 1 via the input/output device 28, the control unit 25 of the towing vehicle 2 accepts this (step S1 of FIG. 11), and transmits a parking preparation request to the control unit 17 of the trailer 1 by vehicle-to-vehicle communication (step S2 of FIG. 11).

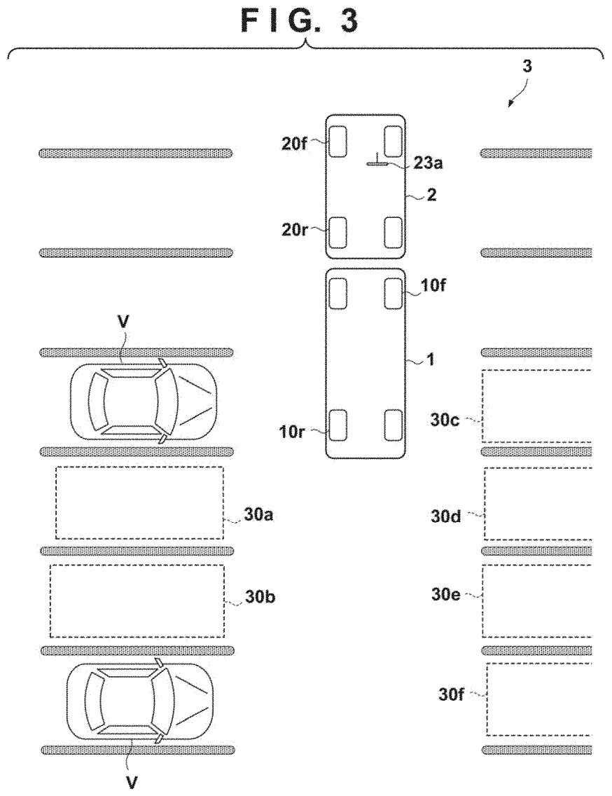

The control unit 17 of the trailer 1 receives the parking preparation request (step S11 of FIG. 11), and recognizes free parking spaces 30 based on the detection result of the detection unit 18 (step S12 of FIG. 11). FIG. 3 shows a situation in which parking spaces 30a to 30f are recognized as parking candidates for the trailer 1. The control unit 17 transmits a notification representing that parking is possible in the parking spaces 30a to 30f in FIG. 3 as the recognition result of parking spaces to the control unit 25 of the towing vehicle 2 by vehicle-to-vehicle communication (step S13 of FIG. 11).

The control unit 25 of the towing vehicle 2 receives the notification (step S3 of FIG. 11). If the towing vehicle 2 is not stopped, the control unit 25 stops the towing vehicle 2, and the trailer 1 is also stopped. As for the stop of the towing vehicle 2, for example, the input/output device 28 urges the occupant to stop, and the occupant performs a stop operation, thereby stopping the towing vehicle 2. After the stop of the towing vehicle 2 and the trailer 1, the control unit 25 displays figures or videos representing the parking spaces 30a to 30f on the input/output device 28, and causes the occupant of the towing vehicle 2 to select a parking space to park the trailer 1. If parking space selection and parking start are instructed on the input/output device 28 by the occupant, the control unit 25 of the towing vehicle 2 transmits a parking instruction of the trailer 1 for the selected parking space to the control unit 17 of the trailer 1 by vehicle-to-vehicle communication (step S4 of FIG. 11).

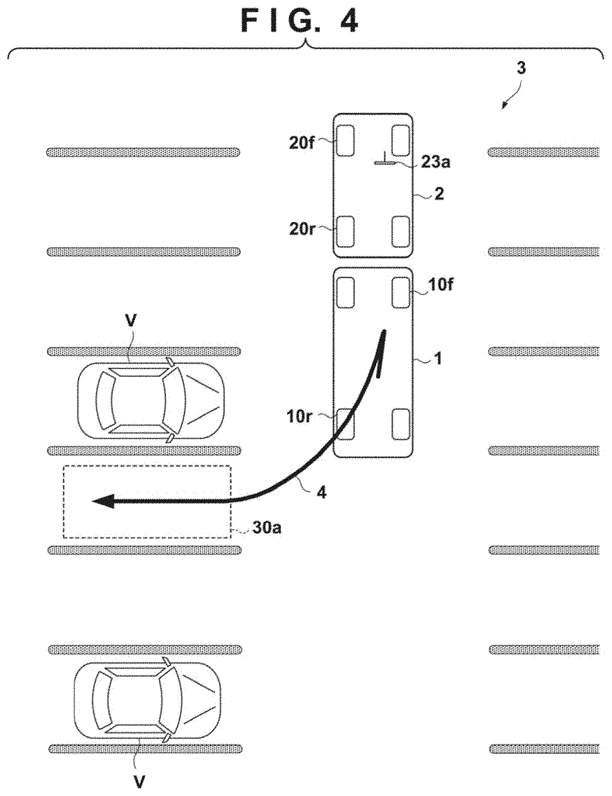

The control unit 17 of the trailer 1 receives the parking instruction (step S14 of FIG. 11), ends automatic following to the towing vehicle 2, and starts automatic parking. In the automatic parking control, the control unit 17 first recognizes the peripheral situation (the existence of other parking vehicles V, structures on the periphery, the position of the parking space 30a, and the like) based on the detection result of the detection unit 18, and calculates and sets a moving track from the stop position to the parking space 30a (step S15 of FIG. 11). FIG. 4 shows a moving track 4 as an example. The moving track 4 shown in FIG. 4 shows an example in which the trailer 1 slightly advances, then retreats to the rear left side, and moves to the parking space 30a.

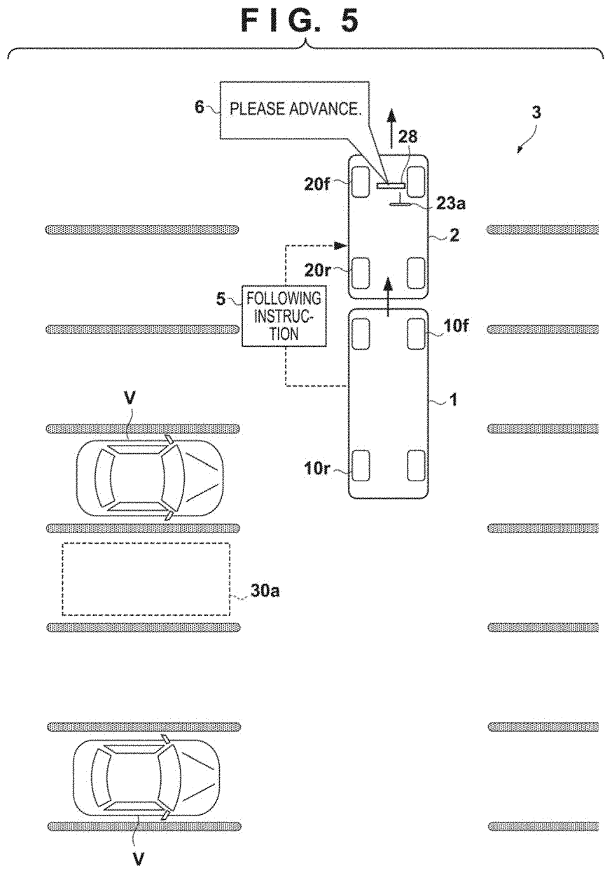

The control unit 17 of the trailer 1 controls driving of the electric traveling mechanism 12 such that the trailer 1 moves along the set moving track (step S16 of FIG. 11). The control unit 25 of the towing vehicle 2 performs corresponding control (step S5 of FIG. 11). An example of moving control in step S16 and corresponding control in step S5 will be described with reference to FIGS. 5 to 8. This control uses vehicle-to-vehicle communication between the control unit 17 and the control unit 25.

The examples shown in FIGS. 5 to 8 assume a case assumed in which the trailer 1 parks in the parking space 30a along the moving track 4 shown in FIG. 4. Since the moving track 4 is a track that makes the trailer 1 advance first, the towing vehicle 2 also needs to advance. The control unit 17 of the trailer 1 transmits a following instruction 5 to the control unit 25 of the towing vehicle 2, as shown in FIG. 5. The following instruction 5 here is an operation instruction to urge the occupant of the towing vehicle to do an advancing operation of the towing vehicle 2. The control unit 25 that has received the following instruction 5 makes, via the input/output device 28, a notification 6 to urge the occupant to perform a driving operation. In the example shown in FIG. 5, a message “please advance” is displayed on the input/output device 28. According to this display, the driver of the towing vehicle 2 performs following driving of the towing vehicle 2 to the trailer 1. More specifically, the towing vehicle 2 is made to advance by operating the accelerator pedal 29a. When the towing vehicle 2 advances, the control unit 17 of the trailer 1 makes the trailer 1 advance.

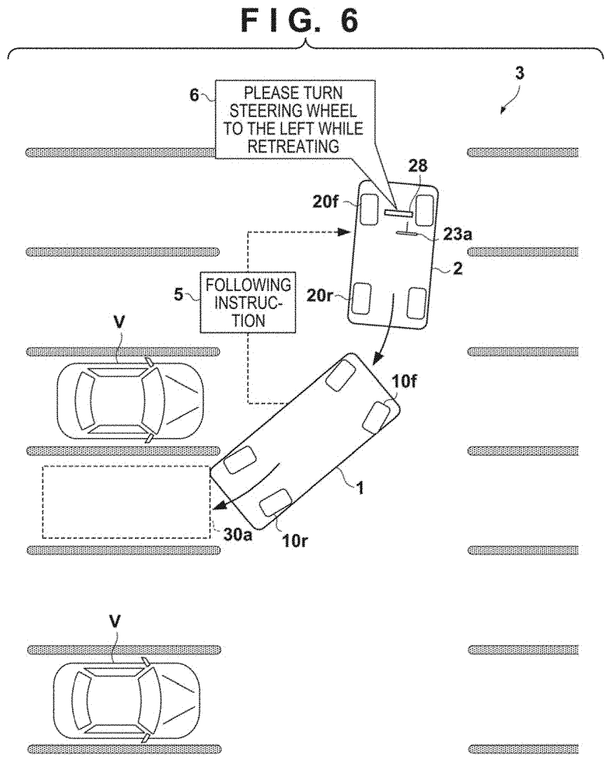

Next, since the moving track 4 is a track that makes the trailer 1 advance and then retreat to the rear left side, the control unit 17 of the trailer 1 makes the trailer 1 retreat to the rear left side. In parallel to this, the control unit 17 of the trailer 1 transmits the following instruction 5 to the control unit 25 of the towing vehicle 2, as shown in FIG. 6. The following instruction 5 here is an operation instruction to urge the occupant of the towing vehicle to make the towing vehicle 2 retreat and perform left steering. The control unit 25 that has received the following instruction 5 makes, via the input/output device 28, the notification 6 to urge the occupant to perform a driving operation. In the example shown in FIG. 6, a message “please turn the steering wheel to the left while retreating” is displayed on the input/output device 28. According to this display, the driver of the towing vehicle 2 selects retreat by the shift lever as following driving, and operates the steering wheel 23a while operating the accelerator pedal 29a, thereby making the towing vehicle 2 retreat to the rear left side. In this way, the inter-vehicle distance between the trailer 1 and the towing vehicle 2 is maintained within a predetermined range, and the towing relationship is maintained. The occupant of the towing vehicle 2 can confirm the behavior of the trailer 1.

Note that the control unit 17 of the trailer 1 may monitor whether the towing vehicle 2 is following the trailer 1 in accordance with the following instruction. Upon determining that the towing vehicle 2 is not following (for example, if the distance between the trailer 1 and the towing vehicle 2 is a predetermined distance or more), the control unit 17 may stop the automatic parking and stand by there.

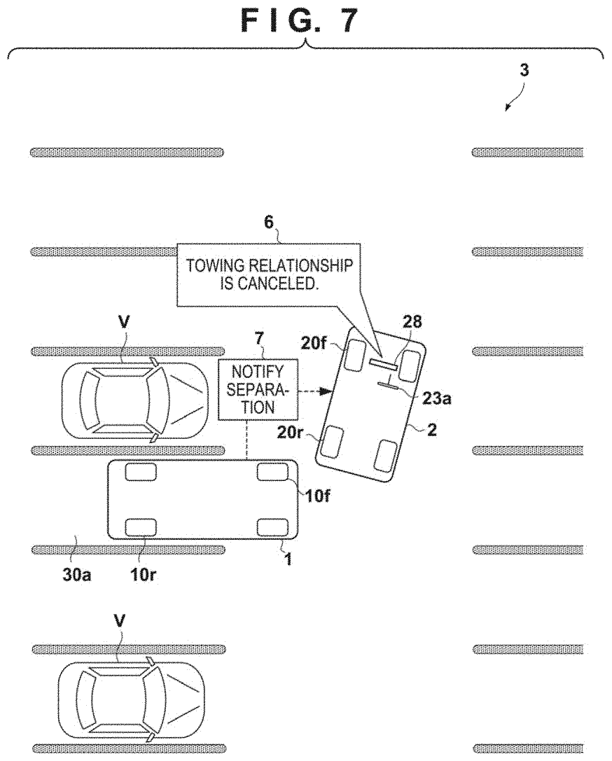

On the other hand, as the automatic parking of the trailer 1 progresses, it may be not appropriate to maintain the towing relationship depending on the positional relationship between the trailer 1 and the towing vehicle 2. In this case, the towing relationship between the trailer 1 and the towing vehicle 2 is canceled. FIG. 7 shows an example. In the illustrated example, the trailer 1 has a posture parallel to the parking space 30a, and a part of the trailer 1 is entering the parking space 30a. On the other hand, the towing vehicle 2 has a posture tilting with respect to the trailer 1. When the towing vehicle 2 is going to follow the trailer 1, the towing vehicle 2 may protrude to the parking space facing the parking space 30a. Under this situation, the necessity of maintaining the towing relationship is low.

The control unit 17 of the trailer 1 transmits a separation notification 7 representing cancel of the towing relationship to the control unit 25 of the towing vehicle 2. The control unit 25 that has received the separation notification 7 makes, to the occupant via the input/output device 28, the notification 6 representing that the towing relationship is canceled. The driver of the towing vehicle 2 stops the following driving of the towing vehicle 2 to the trailer 1.

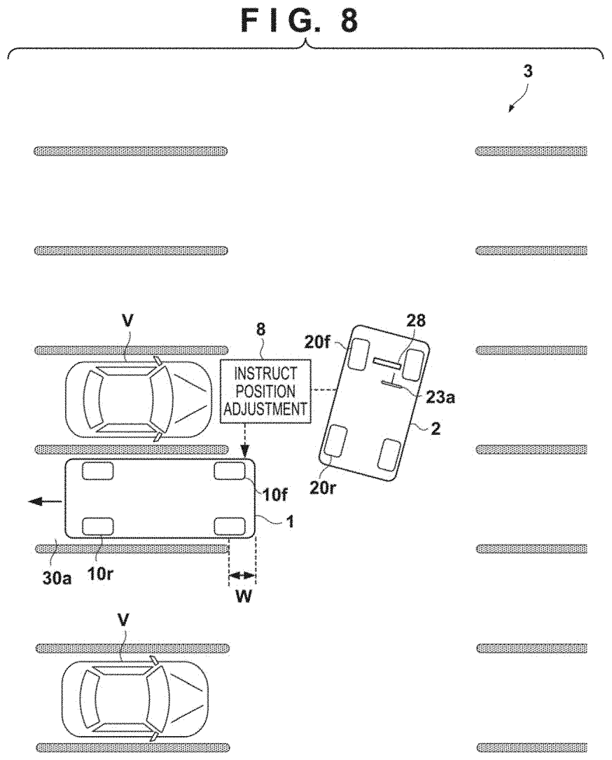

Next, the control unit 17 of the trailer 1 continues the movement of the trailer 1 and parks the trailer 1 in the parking space 30a along the moving track 4. However, in some cases, the trailer 1 is parked in the parking space 30a with a slight shift. In this embodiment, the occupant of the towing vehicle 2 can instruct the position adjustment of the trailer 1. FIG. 8 shows an example.

In the example shown in FIG. 8, a state is assumed in which parking is completed with the front end portion of the trailer 1 protruding from the parking space 30a by a width W. The occupant of the towing vehicle 2 can visually confirm the parking form of the trailer 1 from the inside of the vehicle, and instruct position adjustment (here, retreat of the trailer 1) using the input/output device 28. The control unit 25 of the towing vehicle 2 transmits a position adjustment instruction 8 to the control unit 17 of the trailer 1. The control unit 17 of the trailer 1, which has received the position adjustment instruction 8, makes the trailer 1 retreat, thereby adjusting the parking position. The contents of the position adjustment instruction are not limited to retreat and can include advance, left/right movement, and posture correction of the trailer 1 with respect to the parking space 30a. In a case of left/right movement or posture correction of the trailer 1, the control unit 17 of the trailer 1 sometimes makes the trailer 1 temporarily advance and then retreat while steering the trailer 1, thereby performing desired position adjustment.

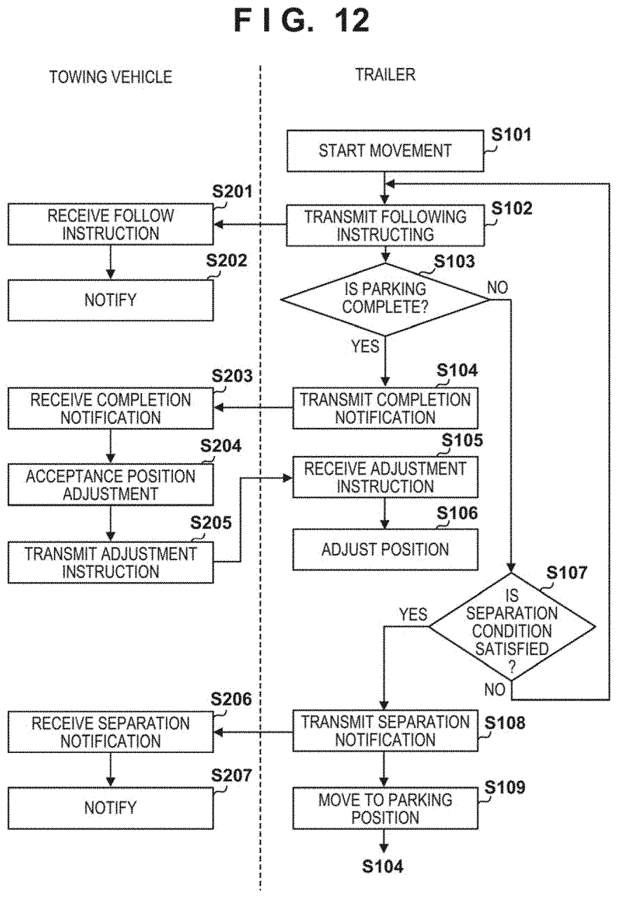

FIG. 12 shows an example of processing of the control unit 17 and the control unit 25 concerning automatic parking control (step S16 of FIG. 11) of the trailer 1 and corresponding control (step S5 of FIG. 11) of the towing vehicle 2 shown in FIGS. 5 to 8.

When automatic parking control of the trailer 1 is started, in step S101, the control unit 17 of the trailer 1 starts moving the trailer 1 along the moving track 4, and in step S102, specifies the moving form to the towing vehicle 2, and transmits a following instruction to the control unit 25 of the towing vehicle 2 (the following instruction 5 in FIG. 5 or 6). In step S201, the control unit 25 of the towing vehicle 2 receives the following instruction, and in step S202, notifies the occupant of the towing vehicle 2 of the contents of the following instruction via the input/output device 28 (the notification 6 in FIG. 5 or 6). If the towing vehicle 2 does not move in accordance with the following instruction, the control unit 17 of the trailer 1 may stop the movement of the trailer 1.

In step S103, the control unit 17 of the trailer 1 determines whether the trailer 1 has moved to the target parking space, and the parking is completed. If the parking is completed, the process advances to step S104. If the parking is not completed, the process advances to step S107.

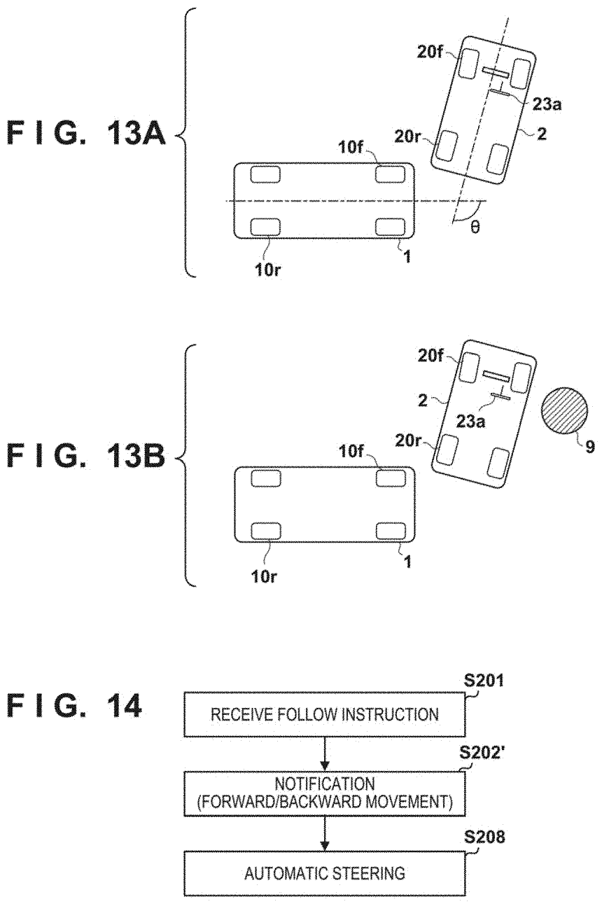

In step S107, the control unit 17 of the trailer 1 determines whether a separation condition is satisfied. The separation condition is a condition to cancel the towing relationship between the trailer 1 and the towing vehicle 2 (FIG. 7). FIGS. 13A and 13B are explanatory views showing examples of separation conditions.

FIG. 13A shows a condition concerning an angle θ made by the total length direction of the trailer 1 and the total length direction of the towing vehicle 2. If the angle θ has become smaller than a threshold (for example, a value within the range of 90° to 120°), it can be determined that the separation condition is satisfied. The total length direction of the trailer 1 and the total length direction of the towing vehicle 2 may be specified by the control unit 17 and the control unit 25, respectively, using sensors provided on the vehicles, and the control unit 25 may notify the control unit 17 of the specified total length direction. Alternatively, the control unit 17 may specify the total length directions of the trailer 1 and the towing vehicle 2 using sensors provided on the trailer 1.

FIG. 13B shows a condition concerning following difficulty of the towing vehicle 2. If the existence of an obstacle 9 makes it difficult for the towing vehicle 2 to follow the trailer 1, it can be determined that the separation condition is satisfied. The obstacle 9 may be detected by the control unit 25 using sensors provided on the towing vehicle 2, and the control unit 17 may be notified of the detection result. Alternatively, the control unit 17 may detect the obstacle 9 using sensors provided on the trailer 1.

As another separation condition, a separation instruction of the occupant of the towing vehicle 2 may be used as the separation condition. The separation instruction of the occupant of the towing vehicle 2 may be accepted by, for example, input of the occupant to the input/output device 28, and the control unit 25 may notify the control unit 17 of it.

Referring back to FIG. 12, if the control unit 17 of the trailer 1 determines in step S107 that the separation condition is satisfied, the process advances to step S108. if the separation condition is not satisfied, the process returns to step S102. In step S108, the control unit 17 of the trailer 1 transmits a separation notification to the control unit 25 of the towing vehicle 2 (the separation notification 7 in FIG. 7). In step S206, the control unit 25 of the towing vehicle 2 receives the separation notification, and in step S207, notifies the occupant of the towing vehicle 2, via the input/output device 28, that the towing relationship has been canceled (the notification 6 in FIG. 7).

In step S109, the control unit 17 of the trailer 1 moves the trailer 1 to the parking space. If the parking is completed, the process advances to step S104. As described above, if it is determined in step S107 that the separation condition is satisfied, the towing relationship between the trailer 1 and the towing vehicle 2 is canceled. Hence, the process of step S102 is not executed, and transmission of the following instruction is ended.

In step S104, the control unit 17 of the trailer 1 transmits, to the control unit 25 of the towing vehicle 2, a completion notification representing that the automatic parking of the trailer 1 is completed. However, in this stage, the parking position of the trailer 1 may be shifted with respect to the parking space, as shown in FIG. 8. In step S203, the control unit 25 of the towing vehicle 2 receives the completion notification, and in step S204, performs position adjustment acceptance processing. In this processing, for example, a user interface that allows the occupant of the towing vehicle 2 to instruct position adjustment is displayed on the input/output device 28. On the user interface, for example, advance of the trailer 1, retreat, left/right, posture, or the amount thereof (50 cm, 1 m, angle, and the like) may be instructed.

If the position adjustment instruction is received from the occupant of the towing vehicle 2, in step S205, the control unit 25 of the towing vehicle 2 transmits the position adjustment instruction to the control unit 17 of the trailer 1 (the position adjustment instruction 8 in FIG. 8). In step S105, the control unit 17 of the trailer 1 receives the position adjustment instruction, and in step S106, moves the trailer 1 to adjust its position.

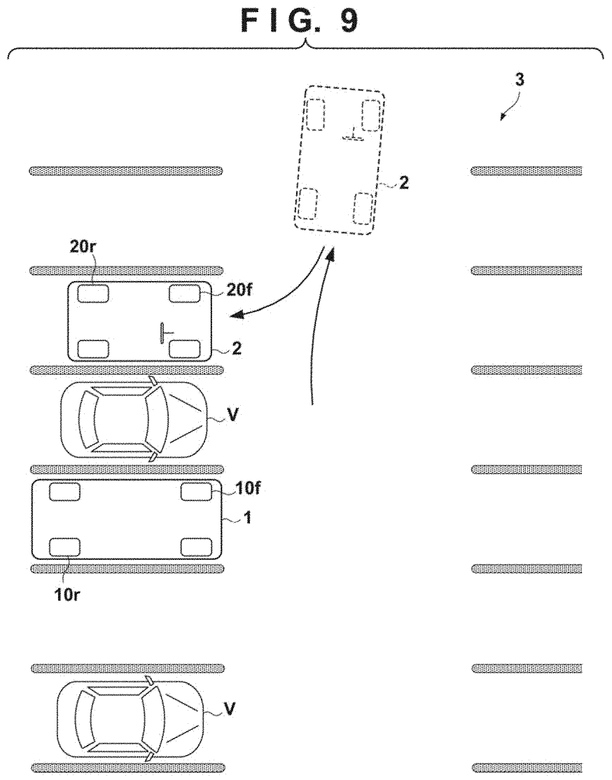

The parking of the trailer 1 is thus completed. When parking of the trailer 1 is completed, the driver of the towing vehicle 2 parks the towing vehicle 2 in a parking space he/she likes. For example, as in an example of FIG. 9, the trailer 1 and the towing vehicle 2 can be parked in separate parking spaces.

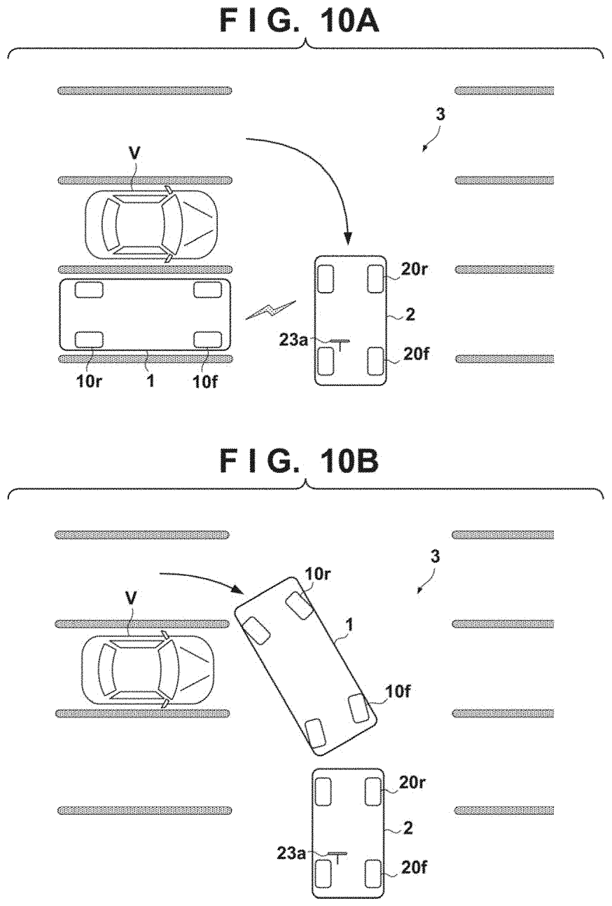

FIG. 10A shows a case in which the towing vehicle 2 departs from the parking lot 3. Steps S7 and S17 to S19 of FIG. 11 show an example of processing of the control unit 25 of the towing vehicle 2 and the control unit 17 of the trailer 1 at that time.

The control unit 25 of the towing vehicle 2 transmits a start request to the control unit 17 of the trailer 1 by vehicle-to-vehicle communication (step S7 of FIG. 11). The control unit 17 of the trailer 1, which has received the start request, starts start control (steps S17 and S18 of FIG. 11). In the start control, the control unit 17 recognizes the existence of the towing vehicle 2 based on the detection result of the detection unit 18, and moves the trailer 1 to a position behind the towing vehicle 2, as shown in FIG. 10B. Next, automatic following traveling to the towing vehicle 2 is started (step S19 of FIG. 11). Since it is easy to return to the automatic following traveling after parking, the convenience of the trailer 1 improves for the occupant of the towing vehicle 2.

### Second Embodiment

In the first embodiment, at the time of automatic parking of the trailer 1, the towing vehicle 2 is made to follow the trailer 1 by the driving operation of the driver. However, the following driving of the towing vehicle 2 may wholly or partially be automated. FIG. 14 shows an example of processing of a control unit 25 of a towing vehicle 2, and shows a processing example that replaces steps S201 and S202 in FIG. 12. In this embodiment, steering of the towing vehicle 2 is automated, and advance/retreat is done by the driving operation of the driver of the towing vehicle 2. However, advance/retreat may also be automated.

In step S201, a following instruction is received from a control unit 17 of a trailer 1. The following instruction can include contents that urge the driver of the towing vehicle 2 to make the trailer 1 advance or retreat and a control instruction that instructs automatic steering of the towing vehicle 2. In step S202′, the occupant of the towing vehicle 2 is notified of the contents of the following instruction via an input/output device 28. Here, a notification that urges the occupant to make the towing vehicle 2 advance or retreat is made, and it is notified that the steering is automatically performed. In step S208, in accordance with the driving operation (advance or retreat) of the driver of the towing vehicle 2, the control unit 25 drives an electric power steering mechanism 23 and automatically steers the towing vehicle 2, thereby assisting following traveling to the trailer 1.

### Summary of Embodiment

The above embodiment discloses at least the following trailer.

1. According to the above embodiment, there is provided an electric self-traveling trailer (1) capable of performing automatic following traveling to a towing vehicle (2) without mechanical connection, comprising:
a detection unit (18) configured to detect a peripheral situation;
a recognition unit (17, S12) configured to recognize a parking space based on a detection result of the detection unit;

a moving control unit (17, S16) configured to move the trailer to the parking space; and
an instruction unit (17, S102) configured to transmit, to the towing vehicle, a following instruction for making the towing vehicle follow the trailer moving to the parking space.

According to this embodiment, it is possible to provide a technique of maintaining a towing state even in automatic parking of a trailer and enabling safe and convenient parking that a driver can easily confirm.

2. In the above embodiment,
the following instruction (5) includes an operation instruction for urging a driver of the towing vehicle to perform an advance/retreat operation of the towing vehicle.

According to this embodiment, it is possible to support the driving operation of the driver when making the towing vehicle follow automatic parking of the trailer.

3. In the above embodiment,
the following instruction (5) includes an operation instruction for urging a driver of the towing vehicle to steer the towing vehicle.

According to this embodiment, it is possible to support the driving operation of the driver when making the towing vehicle follow automatic parking of the trailer.

4. In the above embodiment,
the following instruction includes a control instruction for instructing the towing vehicle to perform automatic steering of the towing vehicle.

According to this embodiment, it is possible to obviate the necessity of a steering operation of the driver and facilitate monitoring of the trailer when making the towing vehicle follow automatic parking of the trailer.

5. In the above embodiment,
the instruction unit ends the transmission of the following instruction if a separation condition between the towing vehicle and the trailer is satisfied during movement of the trailer to the parking space (S107-S109).

According to this embodiment, if it is difficult to maintain the towing relationship between the trailer during automatic parking and the towing vehicle, it is possible to cancel the towing relationship and continue the automatic parking of the trailer.

6. In the above embodiment,
after the movement of the trailer to the parking space, if a position adjustment instruction is received from the towing vehicle, the moving control unit adjusts a parking position of the trailer in correspondence with the position adjustment instruction (S105, S106).

According to this embodiment, if the automatic parking completion position of the trailer has a shift, it is possible to facilitate position adjustment.

The invention is not limited to the foregoing embodiments, and various variations/changes are possible within the spirit of the invention.

What is claimed is:

1. An electric self-traveling trailer capable of performing automatic following traveling to a towing vehicle without mechanical connection, comprising:
a detection unit configured to detect a peripheral situation;
a recognition unit configured to recognize a parking space based on a detection result of the detection unit;
a moving control unit configured to move the trailer to the parking space; and
an instruction unit configured to transmit, to the towing vehicle, a following instruction for making the towing vehicle follow the trailer moving to the parking space.

2. The trailer according to claim 1, wherein the following instruction includes an operation instruction for urging a driver of the towing vehicle to perform an advance/retreat operation of the towing vehicle.

3. The trailer according to claim 1, wherein the following instruction includes an operation instruction for urging a driver of the towing vehicle to steer the towing vehicle.

4. The trailer according to claim 1, wherein the following instruction includes a control instruction for instructing the towing vehicle to perform automatic steering of the towing vehicle.

5. The trailer according to claim 1, wherein the instruction unit ends the transmission of the following instruction if a separation condition between the towing vehicle and the trailer is satisfied during movement of the trailer to the parking space.

6. The trailer according to claim 1, wherein after the movement of the trailer to the parking space, if a position adjustment instruction is received from the towing vehicle, the moving control unit adjusts a parking position of the trailer in correspondence with the position adjustment instruction.
